(19) United States
(12) Patent Application Publication
(10) Pub. No.: US 2025/0365455 A1
(43) Pub. Date: Nov. 27, 2025

(54) LIVE STREAMING IN MULTI-CONTENT DELIVERY NETWORKS

(71) Applicant: Bytedance Technology Ltd., Grand Cayman (KY)

(72) Inventors: Yanlin ZHOU, Los Angeles, CA (US); Yingan WANG, Los Angeles, CA (US); Yifei GE, Los Angeles, CA (US)

(21) Appl. No.: 19/293,182

(22) Filed: Aug. 7, 2025

(51) Int. Cl. H04N 21/231; H04N 21/2187; H04N 21/2343

(52) U.S. Cl. CPC H04N 21/23106; H04N 21/2187; H04N 21/234309

(57) ABSTRACT

In one embodiment, a method includes receiving, at an auxiliary network from a content delivery network of multiple content delivery networks, a first copy of a recorded digital content stream, and transmitting, from the auxiliary network to a first storage associated with the auxiliary network, the first copy of the recorded digital content stream. The recorded digital content stream corresponds to a digital content stream generated by a user device and received and recorded by the content delivery network and includes multiple content segments. The first copy of the recorded digital content stream includes a copy of the content segments and a corresponding playlist. The first copy of the recorded digital content stream is accessible to the user device. Moreover, a second copy of the recorded digital content stream is stored by a second storage associated with the content delivery network.

### TECHNICAL FIELD

This disclosure relates generally to live streaming of digital content, and in particular relates to systems and methods for transmitting a digital content stream over multi-content delivery networks (multi-CDNs).

### BACKGROUND

Live streaming platforms commonly rely on content delivery networks (CDNs) to intake, record, and distribute digital content. Traditional architectures typically utilize a single in-house CDN to handle both real-time streaming and post-processing tasks, such as content review and editing. However, as streaming platforms scale to support a growing number of concurrent broadcasters, single CDN approaches may struggle with bandwidth limitations. On the other hand, some platforms may employ a multi-CDN framework to improve scalability. But it introduces new inefficiencies, such as redundant storage, high CDN service costs, delayed content availability, and increased risk of data loss. Thus, there is a need for a live streaming solution that improves delivery efficiency while enhancing reliability and reducing operational costs.

### SUMMARY

In particular embodiments, a method includes receiving, at an auxiliary network from a content delivery network of a plurality of content delivery networks, a first copy of a recorded digital content stream, and transmitting, from the auxiliary network to a first storage associated with the auxiliary network, the first copy of the recorded digital content stream. The recorded digital content stream corresponds to a digital content stream generated by a user device and received and recorded by the content delivery network. The recorded digital content stream includes a plurality of content segments. The first copy of the recorded digital content stream includes a copy of the plurality of content segments and a corresponding playlist. The first copy of the recorded digital content stream is accessible to the user device. A second copy of the recorded digital content stream is stored by a second storage associated with the content delivery network.

In particular embodiments, one or more computer-readable non-transitory storage media are provided. The storage media embody software that is operable when executed to perform operations including: receiving, at an auxiliary network from a content delivery network of a plurality of content delivery networks, a first copy of a recorded digital content stream; and transmitting, from the auxiliary network to a first storage associated with the auxiliary network, the first copy of the recorded digital content stream. The recorded digital content stream corresponds to a digital content stream generated by a user device and received and recorded by the content delivery network. The recorded digital content stream includes a plurality of content segments. The first copy of the recorded digital content stream includes a copy of the plurality of content segments and a corresponding playlist. The first copy of the recorded digital content stream is accessible to the user device. A second copy of the recorded digital content stream is stored by a second storage associated with the content delivery network.

In particular embodiments, a system includes one or more processors and one or more computer-readable non-transitory storage media coupled to one or more of the processors. The storage media include instructions operable when executed by one or more of the processors to cause the system to perform operations including: receiving, at an auxiliary network from a content delivery network of a plurality of content delivery networks, a first copy of a recorded digital content stream; and transmitting, from the auxiliary network to a first storage associated with the auxiliary network, the first copy of the recorded digital content stream. The recorded digital content stream corresponds to a digital content stream generated by a user device and received and recorded by the content delivery network. The recorded digital content stream includes a plurality of content segments. The first copy of the recorded digital content stream includes a copy of the plurality of content segments and a corresponding playlist. The first copy of the recorded digital content stream is accessible to the user device. A second copy of the recorded digital content stream is stored by a second storage associated with the content delivery network.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment for content delivery services.

FIG. 2 illustrates an example network environment that supports multi-CDN according to particular embodiments of the disclosure.

FIG. 3 illustrates an example flow chart of a method for digital content delivery according to particular embodiments of the disclosure.

FIG. 4 illustrates an example computer system.

### DETAILED DESCRIPTION

Content streaming platforms may typically utilize a single ingest content delivery network (CDN) for live streaming and post-processing workflows. For example, existing streaming service providers may usually employ an in-house CDN infrastructure (i.e., a system operated and managed by the streaming platforms themselves) to receive live digital content from broadcasters and content creators. The in-house CDN may be configured to perform real-time segmentation of the incoming live stream into short content segments, formatted according to protocols such as HTTP Live Streaming (HLS) or Dynamic Adaptive Streaming over HTTP (DASH). During the live broadcast, the CDN may record the segmented data in a storage system within the platform's private network. Upon completion of the broadcast, the system may then transcode the recorded segments into a compressed video file format (e.g., MP4), thereby allowing the content creator to download the content for local use, such as for reviewing and editing. Because only a single CDN is involved and operates within the platform—a single CDN for both content ingesting and recording, the recorded media does not leave the private network, and only one persistent copy of the content is retained.

However, the single CDN solution may not meet the increasing demand to support a significantly larger number of concurrent users. To address this scalability issue and improve fault tolerance and geographic limitations, a multi-CDN ingest architecture may be employed, in which the digital content is pushed to multiple independent CDN services. Specifically, for example, each of the CDN providers may operate one or more geographically distributed edge nodes that perform real-time ingest, segmentation, and delivery of the live stream. This multi-CDN architecture provides robustness in the event of partial failure of any single CDN vendor: for example, if one CDN becomes unavailable, the other CDN(s) may continue delivering and recording the stream without interruption to the end-user experience.

Such a multi-CDN ingest design may address challenges such as limited uplink or ingest bandwidth in regions where the platform lacks a direct point of presence (POP), constrained transcoding capacity in high-volume scenarios, and so forth. Particularly, each CDN vendor may provide its own distributed just-in-time (JIT) encoding infrastructure, which allows transcoding operations to be performed in parallel and closer to the data source. As a result, the system can ingest live streams from broadcasters in diverse regions with reduced packet loss and improved availability.

After the live streaming concludes, it may be desirable to provide the content creator with post-broadcast features. To this end, for example, the platform may generate a downloadable and widely compatible file (e.g., an MP4 file) of the complete show content, which may be accessed through a one-click download. Additionally, for example, the platform may incorporate internal cloud-based editing tools that enable the creators to trim segments, insert watermarks, generate highlight reels, or perform other content editing operations, without requiring content re-upload or local file handling.

To support these post-streaming functions, an additional processing pipeline is introduced. Specifically, in operation, during the live streaming, each commercial CDN may record the incoming stream based on the HLS protocol, such as a series of Transport Stream (.ts) segments, which are made accessible for auditors to perform near-real-time analysis, review, or audit. The platform's internal storage may then retrieve, via a public network pathway, the recorded segments. Moreover, in order to bridge the gap between the recording format used by the external CDN and the final deliverable format required for the user-facing tools, the platform needs to perform a transcoding operation to reformat the content copy, such as from .ts to MP4. Such transcoding, along with the need to first retrieve the full content from the commercial CDN over the public network (especially during peak hours or when the live stream is long), introduces latency and increases data transfer overhead.

Due to one or more of these architectural limitations, the use of multi-CDN for ingest and recording faces a number of shortcomings. For example, each participating CDN may retain a full copy of the recorded content segments, typically with a relatively long time-to-live (TTL) setting to support compliance auditing. At the same time, the platform storage independently stores another complete copy of the same content after retrieving it from the CDN. This results in duplicated storage across systems and unnecessary data redundancy. Moreover, for example, the retrieval of the content segments from CDN storage into the platform storage may involve substantial public egress bandwidth consumption. Due to the high volume of concurrently active streams, the platform may transfer multiple petabytes of media data per month from CDNs into its own backbone network, placing strain on public internet links and increasing latency. These inefficiencies contribute to significant operational costs, including but not limited to redundant storage payments, egress traffic charges, request-based access fees, and so on.

In addition, such a streaming framework may result in delays for broadcasters attempting to access the post-streaming functions. For example, the content creator may need to wait for the complete download of content segments from the CDN and the subsequent re-upload or ingestion into the platform's internal storage before any download or cloud editing becomes available. During peak network usage periods, congestion on public network links may cause even more extended queue times, with possible delays reaching several hours.

Furthermore, in the absence of a fallback recording path, recording failures on the CDN side may lead to permanent data loss. Specifically, if a given CDN fails to properly record, retain, or deliver the content segments, the streamed content may become unrecoverable. This poses compliance risks to platform operations.

To address one or more of the aforementioned challenges, particular embodiments disclosed herein present a multi-CDN solution with side-push mirroring and a tiered content retention architecture. In particular embodiments, in addition to a content recording and storage path associated with the multi-CDN, a mirrored copy of the digital content may be synchronously pushed into an auxiliary network associated with the streaming platform. This mirrored copy may then be stored in an extra storage system coupled to the auxiliary network. In particular embodiments, the extra storage of the auxiliary network may be a unified storage layer configured with long-term data retention, capable of supporting both near-real-time content streaming during a live session and post-streaming video-on-demand access, as will be discussed in greater detail below. Configured as such, particular embodiments of the disclosure may improve delivery reliability, minimize bandwidth consumption, and provide faster content availability for a better user experience.

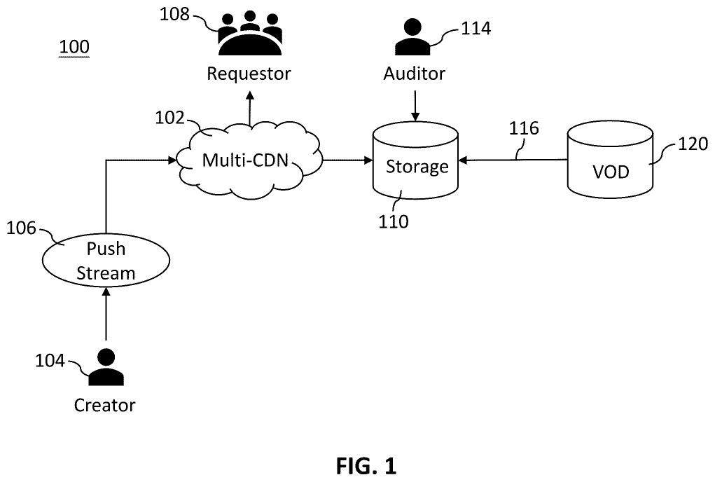

FIG. 1 illustrates an example network environment 100 for content delivery services. In practice, a content creator 104 may initiate a digital content stream via a push stream 106 to multiple content delivery networks (multi-CDN) 102. The content delivery networks 102 may include one or more nodes or servers operable to distribute the live stream to one or more content requestors 108. A copy of the digital content may be recorded by the content delivery networks 102 to a storage 110. The storage 110, for example, may be configured to store the received content with a relatively long TTL setting to support compliance auditing by an auditor 114. In order for the content creator 104 to be able to access the streamed content, a video-on-demand (VOD) storage 120 may be provided, which may be configured to retrieve and download the recorded content from the storage 110 via a public network 116. The VOD storage 120 may similarly be configured with a long-term retention of the digital content and may generate VOD files accessible to the content creator 104. However, as already discussed above, since two copies of the same digital content are retained in parallel (i.e., one by the storage 110, the other by the VOD storage 120) with a long retention period, this results in duplicate storage with increased operational costs. Moreover, the content creator 104 may need to wait for the completion of a full download-and-reupload process before any downloadable VOD files or cloud-based editing functionalities become available.

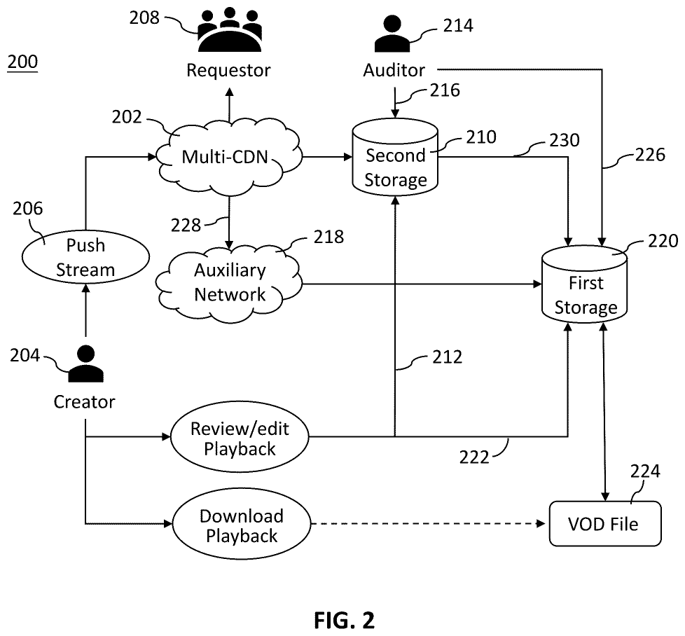

FIG. 2 illustrates an example network environment 200 that supports multi-CDN according to particular embodiments of the disclosure. Particular embodiments disclosed may present a multi-CDN solution with side-push mirroring via an auxiliary network 218 and a tiered content retention architecture having two storages—i.e., a first storage 220 associated with the auxiliary network 218 and a second storage 210 associated with one or more content delivery networks 202. Specifically, in particular embodiments, in addition to a content recording and storage path associated with the content delivery networks 202, a mirrored copy of the digital content may be pushed (e.g., synchronously) into the auxiliary network 218. This mirrored copy may then be stored in the first storage 220 coupled to the auxiliary network 218. In particular embodiments, the first storage 220 of the auxiliary network 218 may be a unified storage layer configured with long-term data retention, capable of supporting both near-real-time content streaming during a live session and post-streaming video-on-demand access, as will be discussed in greater detail below.

In particular embodiments, multiple content delivery networks 202 may be employed, via which content may be uploaded, cached, requested, distributed, or served (the multi-CDN is illustrated as a single network for ease of illustration, but in practice, it includes multiple networks). For instance, the content delivery networks 202 may be commercial services offered by one or more third-party providers or vendors. The content delivery networks 202 may be configured to deploy geographically distributed network servers that are positioned closer to users, in order to deliver content quickly and cheaply. In particular embodiments, the content delivery networks 202 may include multiple nodes or servers configured to communicate with one or more user devices e.g., with a user device associated with a broadcaster or content creator 204 for receiving a digital content from the user device via a push stream 206, or with a user device of a viewer or content requestor 208 for transmitting a requested digital content for display. As an example and not by way of limitation, the server receiving the digital content may be an edge server of the content delivery networks 202, which may be optimally positioned within the network (e.g., closer to the content creator 204) for content servicing. Furthermore, for example, the edge server may also be configured to cache digital content that originates from another node, so that the cached content is available in a location that is closer to the content requestor 208.

As used herein, the term “content” may include any suitable type of data, regardless of its representation and regardless of what the data represents. The term “content” may include, without limitation, text, images (e.g., static and/or dynamic images), audio content (including streamed audio), video content (including streamed video), and the like. Some content may be embedded in other content, e.g., using markup languages such as HTML and XML. The user device may be described herein as a smartphone, but the user may use any suitable types of computing devices to access the content delivery network, including, but not limited to, a tablet, a laptop computer, a desktop computer, a cell phone, a wearable computing device, a gaming device, etc.

In particular embodiments, the digital content received and recorded by each of the content delivery networks 202 may be stored as a content copy on a second storage 210 associated with the content delivery networks 202. Specifically, for example, each of the content delivery networks 202 may be configured to perform real-time segmentation of the incoming live stream into short content segments and transmit the segments to the second storage 210 for temporary retention. In particular embodiments, each of the content delivery networks 202 may be associated with a dedicated second storage 210. Alternatively, one or more centralized second storage 210 may be provided, each shared among multiple content delivery networks 202. In particular embodiments, the second storage 210 may include any suitable type of storage system, such as a cache server, an edge node storage, a distributed object store, or the like. In particular embodiments, the copy of the digital content may be formatted on the second storage 210 using any suitable formatting or packaging techniques. For example, the stored copy may be segmented and organized in accordance with a particular data transfer protocol, such as HLS. As an example and not by way of limitation, the HLS protocol may enable the digital content to be divided into a sequence of short content segments, typically in .ts format, and may append each content segment to a per-stream manifest file, such as an .m3u8 playlist.

In particular embodiments, the second storage 210 may be configured with a short cache control parameter, such as a short time-to-live (TTL) value, which defines how long digital content may remain within the storage. Such a temporary storage may serve as a secondary or backup copy of the content, retained only for a limited duration following ingestion. This may be especially useful for disaster recovery (DR) scenarios, such as when a primary storage (i.e., a first storage 220, as will be described in more detail below) encounters data corruption, incomplete recording, or unexpected service interruptions. As an example and not by way of limitation, when such a failure occurs, the content creator 204 may access the digital content (or specifically, a copy of the content) in the second storage 210 through a backup load path 212, thereby enabling the content creator 204 to review, edit, or playback the streamed content as needed. In particular embodiments, the second storage 210 may also be accessible—similarly via a backup load path 216—to an auditor device associated with an auditor 214 or other authorized auditing personnel or systems for purposes of content review, compliance verification, or security auditing, for example, in the event of primary storage failure. As an example and not by way of limitation, the auditor device may include a smartphone, a tablet, a laptop computer, a desktop computer, a cell phone, a wearable computing device, a gaming device, or other suitable computing device. In particular embodiments, since the respective copy of the digital content is recorded in the second storage 210 in HLS segments (e.g., .ts format) with their corresponding playlist, which aligns with the format requirements for the platform's internal system, the auditor 214 may perform near-real-time segment-level content review without the need for content reformatting. In particular embodiments, the cache control of the second storage 210 may be configured to retain the copy of the digital content stream for a defined period, such as a specified number of hours following ingestion. In particular embodiments, in the event of disaster recovery, the content copy of the second storage 210 may be retrieved and transmitted, via a path 230, to the first storage 220 for long-term preservation, provided that the TTL associated with the content copy in the second storage 210 has not yet expired.

In particular embodiments, in response to receiving the digital content from the user device, the content delivery networks 202 (or more specifically, an associated edge node thereof) may immediately perform a side push operation 228 to transmit (e.g., synchronously) another copy of the recorded digital content to an auxiliary network 218. The auxiliary network 218 may be configured as a side or parallel network resource, which, for example, may be used to offload specific tasks, provide redundancy, support certain traffic management functions, or perform other suitable operations alongside the content delivery networks 202. As an example and not by way of limitation, the auxiliary network 218 may include one or more recorder nodes—or collectively referred to herein as a recording cluster—configured to receive the digital content stream and record it in parallel, without waiting for accumulation or batching of segments. In particular embodiments, the recording cluster may be a cloud digital video recorder (DVR) recording cluster. In particular embodiments, compared to the content delivery networks 202, which may be operated by one or more commercial service providers, the auxiliary network 218 as well as the recording cluster may be hosted within, operated by, or otherwise associated with the streaming platform itself, without outsourcing to third parties.

In particular embodiments, the copy of the digital content may be transmitted in segments, such as those in accordance with the HLS protocol. The recording cluster may be configured to write the received copy of content segments in real-time into a first storage 220 that is associated with the auxiliary network 218. In particular embodiments, the recording cluster may be configured to append each incoming content segment to a per-stream manifest file, such as an .m3u8 playlist, based on the HLS protocol. Both the content segments and the corresponding manifest playlist file may be written and stored in real time to the first storage 220.

In particular embodiments, the first storage 220 may be configured with a long cache control parameter, such as a long time-to-live (TTL) value, allowing the first storage 220 to function as the primary archival source for the digital content stream. As an example and not by way of limitation, the cache control of the first storage 220 may be configured to retain the copy of the digital content stream for an extended period, such as several days or months. In particular embodiments, for example, under normal conditions, the content creator 204 and/or the auditor 216 may access the first storage 220 to retrieve the long-term copy of the recorded digital content for review, editing, or other suitable operations, and may only resort to the backup second storage 210 if the primary first storage 220 becomes unavailable or fails. In particular embodiments, similar to the in-house auxiliary network 218, the first storage 220 may also be hosted within, operated by, or otherwise associated with the streaming platform itself, without outsourcing to third parties. This way, by storing the long-term copy in the low-cost in-house first storage 220, storage costs may be reduced significantly.

In particular embodiments, the first storage 220 may be a unified Live-VOD (video-on-demand) object storage bucket internal to the streaming platform that supports both live stream recording and subsequent on-demand playback. Once the live stream is ended, a complete playlist (e.g., a .m3u8 manifest) corresponding to the recorded segments may already be available, allowing the content creator 204 to immediately initiate post-streaming processing, e.g., via a main load path 222. For example, the content creator 204 may access a cloud-based editing interface through the user device to perform various operations such as trimming the stream, inserting watermarks, or generating highlight clips. In particular embodiments, the first storage 220 may also support download or playback of the entire stream in a downloadable VOD format (e.g., MP4). As an example and not by way of limitation, a VOD file 224 may be generated by stitching together the recorded content segments in real time, a process that may be completed within seconds, and may be made available to the content creator 204 for optional download. This significantly reduces latency compared to other approaches that require downloading the content from the content delivery network and re-uploading it to the platform before editing or transcoding can begin.

In particular embodiments, during live streaming or broadcast, the recording format used by both the second storage 210 and the first storage 220 may remain consistent—for example, both using the HLS protocol as discussed. Configured as such, it may enable the content review processes (e.g., by the content creator 204 via the main load path 222 or the auditor 214 via another main load path 226) to begin in near real time, without requiring format conversion or reprocessing. In addition, dual-path redundancy may be achieved, in which identical content is recorded along two separate recording pathways (i.e., one stored onto the second storage 210, the other on the first storage 220), thereby improving fault tolerance and reliability without necessitating transcoding or intermediate data transfers.

In particular embodiments, the network environment 200 may include one or more network communication devices such as routers, switches, and the like to facilitate data communication among various network components, the details of which are not discussed exhaustively herein to avoid obscuring the scope of the disclosure.

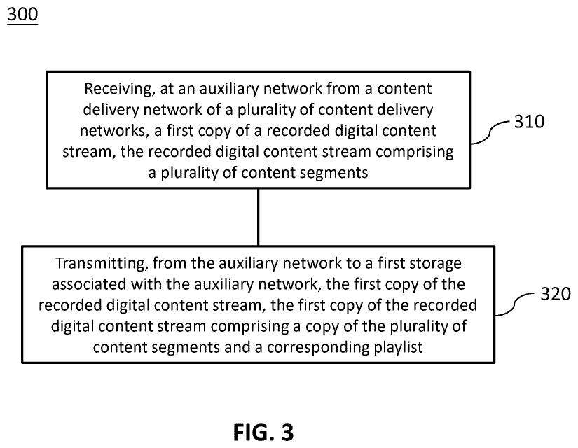

FIG. 3 illustrates a process flow of an example method 300 for digital content delivery. The method 300 may incorporate similar steps described above with reference to FIG. 2 and may be compatible with various embodiments disclosed herein. In particular embodiments, the method 300 may begin once a live streaming is initiated. As an example and not by way of limitation, a digital content stream is generated by a user device and received and recorded at one of the content delivery networks 202. The user device may be associated with a content creator 204. For example, the content creator 204 may initiate a live content stream via the user device, which may be transmitted to a suitable edge node of the content delivery network 202. The digital content stream recorded by the content delivery network 202 may include multiple content segments, such as according to HLS protocol in .ts format along with a corresponding playlist (e.g., an .m3u8 playlist). In particular embodiments, the content delivery networks 202 may be associated with one or more third-party providers, such as commercial CDN vendors, different from the streaming platform.

Once the live streaming is initiated, at step 310, in particular embodiments, an auxiliary network 218 may receive, from the associated content delivery network 202, a first copy of a recorded digital content stream. The recorded digital content stream corresponds to a digital content stream recorded by the content delivery network 202 from the user device. In particular embodiments, the recorded digital content stream may include multiple content segments. In particular embodiments, the auxiliary network 218 may be associated with the streaming platform. In particular embodiments, the auxiliary network 218 includes a recording cluster configured to record the first copy of the recorded digital content stream.

At step 320, the first copy of the recorded digital content stream is transmitted from the auxiliary network 218 to the first storage 220 associated with the auxiliary network 218. Specifically, as an example and not by way of limitation, the first copy of the recorded digital content stream is received at the auxiliary network 218 synchronously as the content delivery network 202 records the digital content stream from the user device. In that regard, for example, in particular embodiments, as soon as the content delivery network 202 records the digital content stream, it may immediately perform a side push operation to synchronously transmit a copy of the digital content stream to the auxiliary network 218. In particular embodiments, the first storage 220 associated with the auxiliary network 218 may store the first copy of the recorded digital content stream. The first copy of the recorded digital content stream may include a copy of the multiple content segments (such as according to the HLS protocol in .ts format) and a corresponding playlist (e.g., an .m3u8 playlist). The first copy of the recorded digital content stream may be accessible to the user device. In particular embodiments, the first copy of the recorded digital content may be long-term cached in the first storage 220. In particular embodiments, the first copy of the recorded digital content stream may be accessible to the user device via a main load path. Similarly, in particular embodiments, the first copy of the recorded digital content stream may be accessible to the auditor device (e.g., a computing device associated with an auditor 214) via a main load path.

In particular embodiments, a second copy of the recorded digital content stream may be stored by a second storage 210 associated with the respective content delivery network 202. In particular embodiments, a cache control (e.g., TTL) of the second storage 210 may be configured differently from the cache control of the first storage 220. As an example and not by way of limitation, the second storage 210 may be configured as a short-term cache, such that the second copy of the recorded digital content stream is temporarily cached in the second storage 210.

In particular embodiments, a protocol of the first copy of the recorded digital content stream may be the same as the protocol of the second copy of the recorded digital content stream. As an example and not by way of limitation, the protocols of the first copy and the second copy of the recorded digital content stream include HLS, which may be suitable for near-real-time reviewing and auditing. As an example and not by way of limitation, similar to the first copy, the second copy of the recorded digital content stream may include a copy of the multiple content segments (such as according to the HLS protocol in .ts format) and a corresponding playlist (e.g., an .m3u8 playlist). In particular embodiments, the second copy of the recorded digital content stream may be accessible to the user device via a backup load path. Similarly, in particular embodiments, the second copy of the recorded digital content stream may be accessible to an auditor device (e.g., a computing device associated with an auditor 214) via a backup load path.

In particular embodiments, the first copy of the recorded digital content stream may be transcoded, by the first storage 220 associated with the auxiliary network 218, into a corresponding video-on-demand (VOD) content, such as an MP4 file. In particular embodiments, the corresponding VOD content may be stored by the first storage 220. As an example and not by way of limitation, the VOD content may be accessible by the content creator 204 via the user device for download or playback.

In particular embodiments, although not illustrated, subsequent to storing the first copy of the recorded digital content stream by the first storage 220, a determination may be made on whether a content segment of the first copy of the recorded digital content stream is missing or corrupted. In particular embodiments, based on determining that the content segment of the first copy of the recorded digital content stream is missing or corrupted, a corresponding content segment of the second copy of the recorded digital content stream may be retrieved from the second storage 210. The retrieved corresponding segment may then be incorporated or patched into the first copy of the recorded digital content stream and stored on the first storage 220 as a primary copy for user access. Alternatively, in particular embodiments, based on determining that the content segment of the first copy of the recorded digital content stream is missing or corrupted, the entire second copy of the recorded digital content stream may be retrieved from the second storage 210. As an example and not by way of limitation, this may occur when the amount of missing or corrupted segments reaches a predetermined threshold over a predetermined time period. For example, if more than 5% of segments are missed within any 60-second window, a backup path may be triggered to initiate a download from the content delivery networks 202 and the associated second storage 210 via a public network, continuing until the auxiliary network 218 recovers and the content is restored.

Additionally or alternatively, in particular embodiments, the content delivery networks 202 may implement a retry mechanism to address segment delivery failures. As an example and not by way of limitation, if a segment fails to be retrieved by or delivered to the auxiliary network 218, a respective content delivery network 202 may automatically attempt to retry the segment side push to the auxiliary network 218 for a predetermined number of retry attempts (e.g., up to five times). If the segment remains unavailable after the maximum number of retries, the segment may be marked or logged as “mirror-missed,” which may be helpful for monitoring delivery health, triggering backup mechanisms, or initiating subsequent recovery actions such as on-demand retrieval from an alternative source (for example, the second storage 210).

Consequently, according to particular embodiments disclosed herein, this end-to-end flow—including immediate side-push mirroring, unified Live-VOD storage, short-term backup retention—eliminates public-network downloads, reduces duplicate long-term storage, significantly lowers bandwidth costs, enables near-instant editing and auditing, and still maintains a safety content copy for disaster recovery purposes.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for digital content delivery including the particular steps of the method of FIG. 3, this disclosure contemplates any suitable method for digital content delivery including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

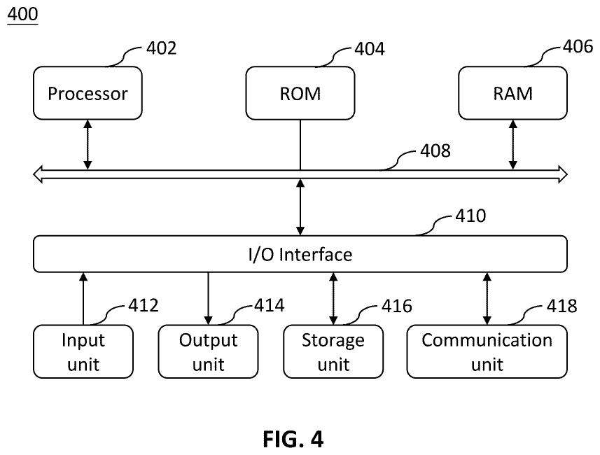

FIG. 4 illustrates a schematic block diagram of a computer system 400 that may be used to implement embodiments of the present disclosure. The computer system 400 may be the device or apparatus described in the embodiments of the present disclosure. As shown in FIG. 4, the computer system 400 includes a processor 402, which may be configured to execute various appropriate actions and processing to perform the methods (e.g., the method 300) of the present disclosure. The processor 402 is implemented in hardware, firmware, or a combination of hardware and software. In addition, although not shown in FIG. 4, the computer system 400 may also include a co-processor.

The processor 402 may execute actions and processing to perform the methods of the present disclosure according to computer program instructions. The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The computer program instructions may be stored in a Read-Only Memory (ROM) 404 or be loaded onto a Random Access Memory (RAM) 406 from a storage unit 416, for example. The processor 402, the ROM 404, and the RAM 406 are connected to each other via bus 408. An input/output (I/O) interface 410 is also connected to bus 408. The various methods or processes described above may be performed by the processor 402.

A plurality of components in computer system 400 are connected to the I/O interface 410, including: an input unit 412, such as a keyboard and a mouse; an output unit 414, such as various types of displays and speakers; the storage unit 416, such as a magnetic disk and an optical disc; and a communication unit 418, such as a network card, a modem, and a wireless communication transceiver. The communication unit 418 allows the computer system 400 to exchange information/data with other devices via a computer network, such as the Internet, and/or various telecommunication networks.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical coding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from those marked in the accompanying drawings. For example, two consecutive blocks may in fact be executed substantially concurrently, and sometimes they may also be executed in a reverse order, depending on the functions involved. It should be further noted that each block in the block diagrams and/or flow charts, as well as a combination of blocks in the block diagrams and/or flow charts, may be implemented using a dedicated hardware-based system that executes specified functions or actions, or using a combination of special hardware and computer instructions.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, at an auxiliary network from a content delivery network of a plurality of content delivery networks, a first copy of a recorded digital content stream, wherein the recorded digital content stream corresponds to a digital content stream generated by a user device and received and recorded by the content delivery network, and wherein the recorded digital content stream comprises a plurality of content segments; and
transmitting, from the auxiliary network to a first storage associated with the auxiliary network, the first copy of the recorded digital content stream, wherein the first copy of the recorded digital content stream comprises a copy of the plurality of content segments and a corresponding playlist, wherein the first copy of the recorded digital content stream is accessible to the user device, and wherein a second copy of the recorded digital content stream is stored by a second storage associated with the content delivery network.

2. The method of claim 1, further comprising:
transcoding, by the first storage associated with the auxiliary network, the first copy of the recorded digital content stream into a corresponding video-on-demand (VOD) content.

3. The method of claim 2, further comprising:
storing, by the first storage associated with the auxiliary network, the corresponding video-on-demand content.

4. The method of claim 1, wherein a cache control of the first storage is different from a cache control of the second storage.

5. The method of claim 1, wherein the first copy of the recorded digital content stream is cached long-term in the first storage.

6. The method of claim 1, wherein the second copy of the recorded digital content stream is temporarily cached in the second storage.

7. The method of claim 1, wherein a protocol of the first copy of the recorded digital content stream is the same as a protocol of the second copy of the recorded digital content stream.

8. The method of claim 7, wherein the protocols of the first copy and the second copy of the recorded digital content stream comprise HTTP Live Streaming (HLS).

9. The method of claim 1, wherein the second copy of the recorded digital content stream comprises a copy of the plurality of content segments and a corresponding playlist.

10. The method of claim 1, wherein the auxiliary network is associated with a streaming platform, and wherein the plurality of content delivery networks is associated with one or more third-party providers.

11. The method of claim 1, wherein the first copy of the recorded digital content stream is accessible to the user device via a main load path, and wherein the second copy of the recorded digital content stream is accessible to the user device via a backup load path.

12. The method of claim 1, wherein the first copy of the recorded digital content stream is accessible to an auditor device via a main load path, and wherein the second copy of the recorded digital content stream is accessible to the auditor device via a backup load path.

13. The method of claim 1, further comprising:
determining whether a content segment of the first copy of the recorded digital content stream is missing or corrupted.

14. The method of claim 13, further comprising:
based on determining that the content segment of the first copy of the recorded digital content stream is missing or corrupted, retrieving, via the auxiliary network, a corresponding content segment of the second copy of the recorded digital content stream from the second storage associated with the content delivery network.

15. The method of claim 14, further comprising:
incorporating the corresponding content segment of the second copy of the recorded digital content stream into the first copy of the recorded digital content stream.

16. The method of claim 13, further comprising:
based on determining that the content segment of the first copy of the recorded digital content stream is missing or corrupted, retrieving, via the auxiliary network, the second copy of the recorded digital content stream from the second storage associated with the content delivery network.

17. The method of claim 1, wherein the first copy of the recorded digital content stream is received at the auxiliary network synchronously as the content delivery network records the digital content stream.

18. The method of claim 1, wherein the auxiliary network comprises a recording cluster configured to record the first copy of the recorded digital content stream.

19. One or more computer-readable non-transitory storage media embodying software that is operable when executed to perform operations comprising:
receiving, at an auxiliary network from a content delivery network of a plurality of content delivery networks, a first copy of a recorded digital content stream, wherein the recorded digital content stream corresponds to a digital content stream generated by a user device and received and recorded by the content delivery network, and wherein the recorded digital content stream comprises a plurality of content segments; and
transmitting, from the auxiliary network to a first storage associated with the auxiliary network, the first copy of the recorded digital content stream, wherein the first copy of the recorded digital content stream comprises a copy of the plurality of content segments and a corresponding playlist, wherein the first copy of the recorded digital content stream is accessible to the user device, and wherein a second copy of the recorded digital content stream is stored by a second storage associated with the content delivery network.

20. A system comprising:
one or more processors; and
one or more computer-readable non-transitory storage media coupled to one or more of the processors and comprising instructions operable when executed by one or more of the processors to cause the system to perform operations comprising:
receiving, at an auxiliary network from a content delivery network of a plurality of content delivery networks, a first copy of a recorded digital content stream, wherein the recorded digital content stream corresponds to a digital content stream generated by a user device and received and recorded by the content delivery network, and wherein the recorded digital content stream comprises a plurality of content segments; and
transmitting, from the auxiliary network to a first storage associated with the auxiliary network, the first copy of the recorded digital content stream, wherein the first copy of the recorded digital content stream comprises a copy of the plurality of content segments and a corresponding playlist, wherein the first copy of the recorded digital content stream is accessible to the user device, and wherein a second copy of the recorded digital content stream is stored by a second storage associated with the content delivery network.
